(19) United States
(12) Patent Application Publication
(10) Pub. No.: US 2025/0306764 A1
(43) Pub. Date: Oct. 2, 2025

(54) ENABLING MULTIPLE PHYSICAL LAYER CONFIGURATION OF MEMORY SUB-SYSTEM WITH MULTIPLE PORTS H

(71) Applicant: Micron Technology, Inc., Boise, ID (US)

(72) Inventors: Steffen Buch, Taufkirchen (DE); Marco Redaelli, Munich (DE)

(21) Appl. No.: 19/069,834

(22) Filed: Mar. 4, 2025

Related U.S. Application Data
(60) Provisional application No. 63/571,906, filed on Mar. 29, 2024.

(51) Int. Cl. G06F 3/06

(52) U.S. Cl. CPC G06F 3/0611; G06F 3/0635; G06F 3/0673

(57) ABSTRACT

A port configuration request is received from a host system of a plurality of host systems. The port configuration request comprises a plurality of port configurations each indicating a physical interface and a communication protocol for an interface port of the plurality of interface ports. An input/output (I/O) controller of each I/O function of a plurality of I/O functions associated with a respective interface port is configured to operate according to the communication protocol of the port configuration associated with the respective interface port for each interface port of the plurality of interface ports based on a port configuration of the plurality of port configurations associated with the respective interface port. A memory access command is executed using an I/O controller of an I/O function connected to the host system responsive to receiving the memory access command from a host system of the plurality of host systems.

### RELATED APPLICATIONS

This application claims the benefit of U.S. Provisional Patent Application No. 63/571,906, filed Mar. 29, 2024, which is incorporated by reference herein.

### TECHNICAL FIELD

Embodiments of the disclosure relate generally to memory sub-systems, and more specifically, relate to enabling multiple physical layer configuration of a memory sub-system with multiple ports.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 illustrates an example computing system that supports multiple physical layer configuration of a memory sub-system with multiple ports in accordance with some embodiments of the present disclosure.

FIG. 3 illustrates a port configuration data structure in a configuration space of the memory sub-system of FIG. 1 in accordance with some embodiments of the present disclosure.

FIG. 4 is a flow diagram of an example method to enable multiple physical layer configuration of memory sub-system with multiple ports in accordance with some embodiments of the present disclosure.

FIG. 5 is a block diagram of an example computer system in which embodiments of the present disclosure may operate.

### DETAILED DESCRIPTION

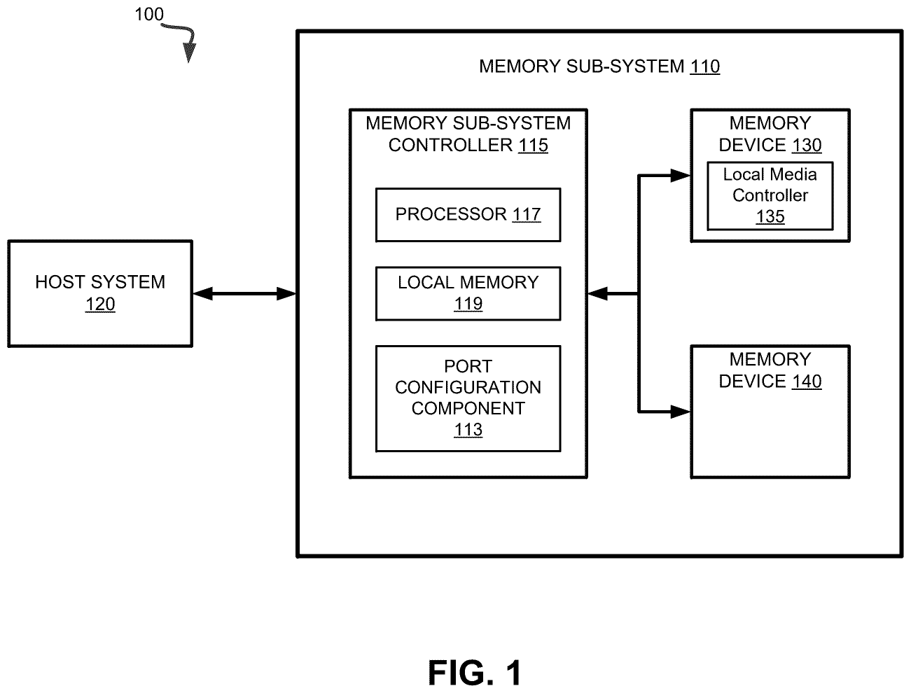

Aspects of the present disclosure are directed to enabling multiple physical layer configuration of a memory sub-system with multiple ports. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

In a conventional memory sub-system, a single interface port can be used to transmit data between the memory sub-system and a host system. Multiple hosts (e.g., different system on a chip (SOC) devices) with multiple virtual machines can interact with the memory sub-system. A virtual machine can be an emulation of a physical host system or other such physical resources of a host system. Thus, the memory sub-system can be used to store and retrieve data for the different virtual machines that are provided by the multiple host systems. In order to manage the transmission of data from the memory devices of the memory sub-system to the different virtual machines at the different host systems, the storage resources of the memory sub-system can be shared through the use of a single interface port that utilizes a single root input/output virtualization (SR-IOV). In some embodiments, the SR-IOV can provide the isolation of the resources of an interface, such as the Peripheral Component Interconnect Express (PCIe), which is used to read data from and write data to the memory sub-system by the different virtual machines. For example, the SR-IOV can provide different virtual functions (VFs) that are each assigned or used by a separate virtual machine.

If the conventional memory sub-system is to be used by multiple host systems, then the single interface port of the memory sub-system is used to share the storage resources of the memory sub-system with the different virtual machines of the different host systems. In order to manage the utilization of multiple host systems with the single interface port, a switch can be used as an intermediary between the memory sub-system and each of the host systems. For example, the switch can be a PCIe switch that provides access to the memory sub-system through the single interface port for each of the host systems. The switch can thus expose the single interface port that utilizes the single root input/output virtualization to each of the different host systems sequentially (i.e., during different access time periods). For example, all of the different virtual functions provided by the SR-IOV can be exposed to all the host systems. However, the utilization of a separate switch can add cost to the memory sub-system and increase power consumption, as the switch is a separate and discrete component that is to be coupled with the host systems. Additionally, the separate switch presents a risk of a single point of failure of the memory sub-system because all host systems are connected to the memory sub-system using the switch. Thus, a failure in the switch can cause all host systems to fail to connect to the memory sub-system.

In order to allow the conventional memory sub-system to be shared for storage by multiple host systems, multiple interface ports can be introduced into the conventional memory sub-system. Each of the multiple interface ports can support single root virtualization. For example, multiple single root input/output virtualization (SR-IOV) enabled interface ports can be provided by the memory sub-system to enable access by the multiple host systems without a need for a separate switch. Typically, the multiple interface ports of the memory sub-system are PCIe ports that can be accessed concurrently with each other, such that the multiple host systems can access the memory sub-system at the same time, or at least during partially overlapping access time periods. Each of the PCIe interface ports can use SR-IOV to provide a separate group of virtual functions to each host system.

Some host systems may be located at a distance that exceeds a maximum connection length of a connection. Connections can include cables, printed circuit board (PCB) lines, board to board (B2B) connectors. Connections, such as a PCIe cable used to connect to a PCIe interface port of the conventional memory sub-system. The maximum length of the PCIe cable is inherently short due to its high-speed nature and the electrical properties of the connection. For example, maintaining signal integrity, strict timing requirements, and power over the PCIe cables becomes increasingly challenging as the length increases. Thus, the length of the PCIe cable is typically set to a maximum connection length (e.g., 30 centimeters or 12 inches).

Other connections, such as ethernet cables may be used to connect the host systems that are positioned at a distance that exceed the maximum connection length of the PCIe cable. Ethernet cables enable connectivity across very long distances (kilometers), albeit with higher latency than PCIe cables. Currently, the conventional memory sub-systems do not support other connections or connections, such as ethernet cables. In order to use ethernet cables to connect the host systems to the conventional memory sub-system, a bridge device is used as an intermediary between the host systems and the conventional memory sub-system. For example, the bridge device can be an ethernet to PCIe bridge device that allows ethernet-based connections via ethernet cables from the host system to interface directly with a PCIe bus of the conventional memory sub-system. The bridge device converts ethernet data packets from the host system into a format that can be understood by the PCIe bus of the conventional memory sub-system, and vice versa. However, the utilization of a separate bridge device can add cost and latency to the conventional memory sub-system. Additionally, if a failure were to occur in the bridge device the host systems connected to the bridge device can fail to connect to the conventional memory sub-system.

Aspects of the present disclosure address the above and other deficiencies by providing a memory sub-system that supports one or more host systems to use a different physical interface (PHY) to connect to the memory sub-system. In particular, a host system queries a configuration space of the memory sub-system to identify a set of port configurations suitable for requirements of the host system. Each port configuration of the set of port configurations includes a port identifier indicating an SR-IOV enabled port (e.g., port) of the memory sub-system, a physical interface (PHY) anticipated for the port, and a communication protocol that supports the PHY of the port. The host system provides the set of port configurations to the memory sub-system, and the memory sub-system configures the plurality of ports based on the set of port configurations. In particular, for each port configuration of the set of port configurations, a port of the plurality of ports is identified by a port identifier of a respective port configuration and an input/output (I/O) controller of each I/O functions of the port is configured to handle commands using a communication protocol of the respective port configuration. The memory sub-system, after configuring the plurality of ports, locks the configuration to prevent any further modification of the plurality of ports. Thus, one or more host systems using various PHY can connect to the memory sub-system without a bridge device.

Advantages of the present disclosure include, but are not limited to, an extended length of the physical connection between a host system and the memory device (e.g., provides a mixture of local and remote data storage), a decreased overall cost of utilizing a memory sub-system connected to multiple host systems via different physical connections, and improved latency of the memory sub-system by preventing the need to use a bridge device and thereby eliminating the associated latency.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes port configuration component 113 that enables memory sub-system 110 to support multiple PHYs and communication protocols. In some embodiments, the memory sub-system controller 115 includes at least a portion of the port configuration component 113. In some embodiments, the port configuration component 113 is part of the host system 120, an application, or an operating system. In other embodiments, local media controller 135 includes at least a portion of port configuration component 113 and is configured to perform the functionality described herein.

Host system 120 queries a configuration space of the memory sub-system 110. The configuration space of the memory sub-system 110 provides, among other things, a plurality of port configuration options. More specifically, the configuration space includes a port configuration data structure that includes the plurality of port configuration options. The port configuration data structure includes a plurality of entries. Each entry of the plurality of entries corresponds to a port configuration option of the plurality of port configuration options. In some embodiments, each entry of the plurality of entries may be identified by a port configuration options identifier (e.g., a numerical identifier corresponding to the port configuration option of the plurality of port configuration options). The plurality of port configuration options is dictated by a number of available ports for the memory sub-system and a number of supported physical interface (PHY). For example, if the number of available ports of the memory sub-system 110 is 4 ports and the number of supported PHY is 2 PHY, the number of port configuration operations may be 16 (e.g., 4 ports multiplied by 2 PHY). Each port configuration option includes a list of port configurations. Each port configuration of the list of port configurations includes a port identifier, a physical interface (PHY), and a communication protocol associated with the PHY.

The PHY can be, for example, Peripheral Component Interconnect Express (PCIe) and ethernet (ETH). The communication protocol, based on the PHY, can be nonvolatile memory express (NVMe) or NVME over fabric (NVMe-OF). NVMe is a communication protocol that enables high-speed access to memory device 130 and/or 140 of the memory sub-system 110 (e.g., NVMe storage devices) through PCIe. NVMe-OF is a communication protocol that extends NVMe to allow the high-performance, low-latency access of NVMe storage devices over network distances through PHY, such as ethernet, extending NVMe benefits beyond local storage (e.g., remote).

Host system 120 selects, from the port configuration data structure, a port configuration option of the plurality of port configuration options based on the requirements of the host system 120. Host system 120 sends a port configuration request including a port configuration option identifier to the memory sub-system 110. The port configuration component 113 receives the port configuration request. The port configuration component 113 obtains, from the port configuration request, the port configuration option identifier. The port configuration component 113 queries the port configuration data structure using the port configuration option identifier to identify an entry corresponding to the port configuration option identifier. The port configuration component 113 obtains, from the entry corresponding to the port configuration option identifier, a list of port configurations.

The memory sub-system 110 may include a plurality of ports. Each port of the plurality of ports may be a single root I/O virtualization (SR-IOV) enabled interface port. SR-IOV allows for the isolation of resources for manageability and performance reasons. The SR-IOV offers different virtual functions to different virtual components on a physical SOC. SR-IOV uses physical and virtual functions to control or configure devices (e.g., the memory sub-system 110). Physical functions have the ability to move data in and out of the device while virtual functions are lightweight functions that support data flowing but also have a restricted set of configuration resources. Accordingly, each port of the plurality of ports includes one or more input/output (I/O) functions. For example, a physical function and one or more virtual functions. Each I/O function includes an I/O controller. Each I/O controller manages commands defined by a communication protocol.

For each port configuration of the list of port configurations, the port configuration component 113 configures a port of the plurality of ports of the memory sub-system 110. More specifically, the port configuration component 113 identifies a port of the plurality of ports identified by a port identifier of a respective port configuration. The port configuration component 113 assigns, to the port of the plurality of ports, a PHY of the respective port configuration and a communication protocol of the respective port configuration. Assigning the communication protocol of the respective port configuration to the port includes enabling (or configuring) an I/O controller of each of the one or more I/O functions of the port to manage commands based on the communication protocol of the respective port configuration.

Responsive to configuring the plurality of ports according to the list of port configurations, the port configuration component 113 may lock the configuration of the plurality of ports. In other words, the configuration of the plurality of ports is unable to be changed. Further details with regards to the operations of the port configuration component 113 are described below.

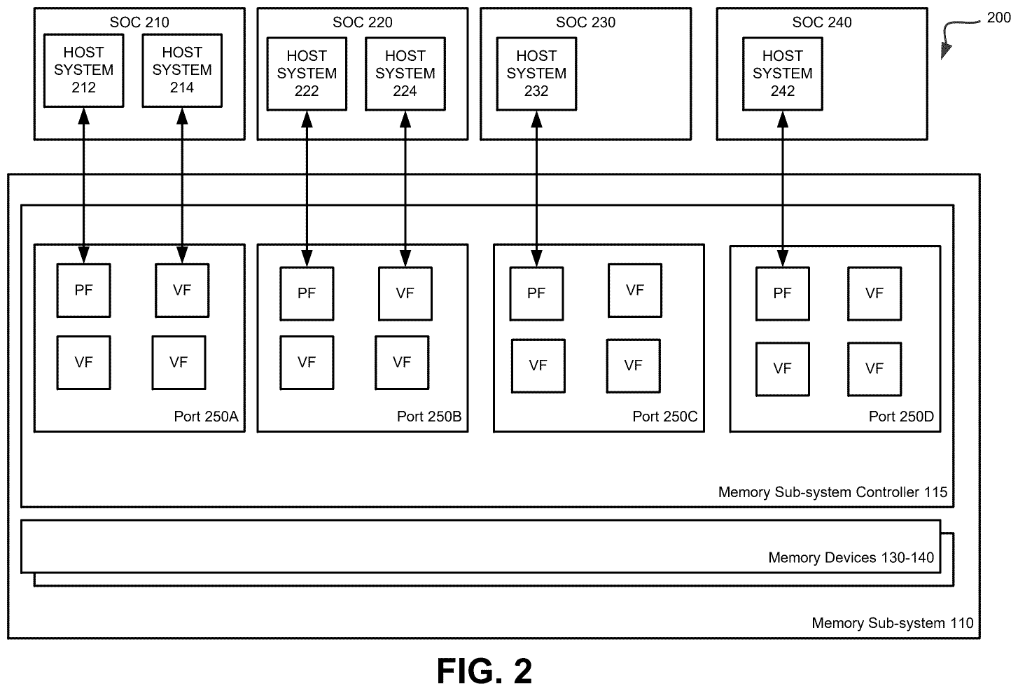

FIG. 2 illustrates an example computing system 200 in accordance with some embodiments of the present disclosure. Memory sub-system 110 can include a plurality of SR-IOV enabled interface ports (e.g., a plurality of ports 250A-D). An SOC (e.g., SOC 210) of the plurality of SOCs (e.g., SOCs 210-240) may be initially connected to one of the plurality of ports 250A-D or sideband(s) of the memory sub-system 110. Sideband(s) refers to an additional communication channel(s) or pathways that are used alongside the main data transfer pathways (e.g., the plurality of ports 250A-D). These sidebands are not used for the primary data flow; instead, they carry control signals, management information, status updates, or auxiliary data.

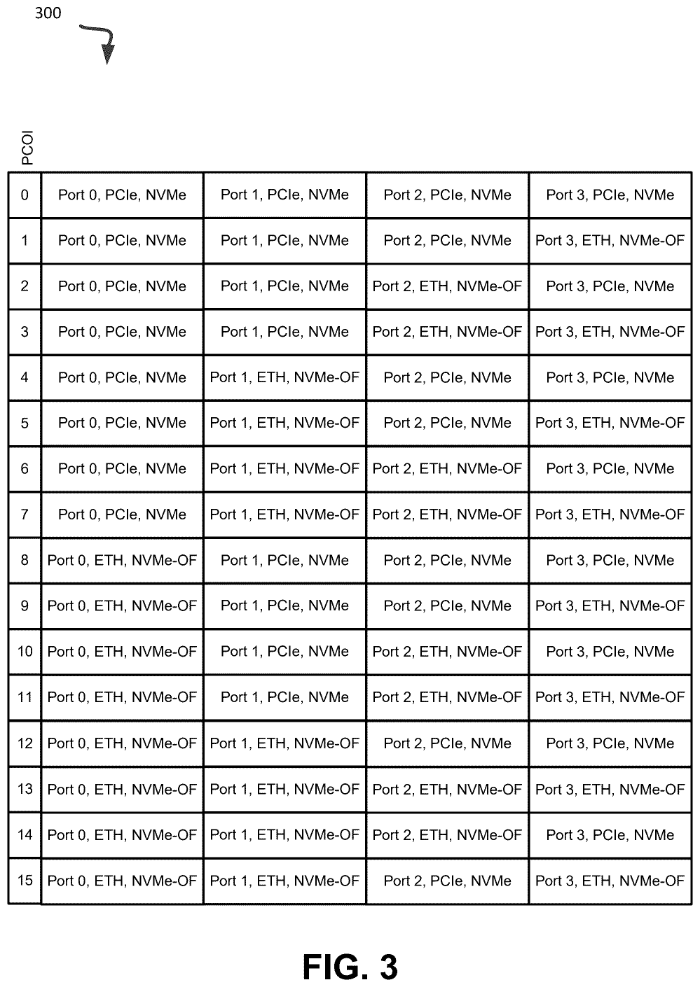

Responsive to powering on a host system of the SOC 210 (e.g., host system 212), the host system 212 detects the memory sub-system 110 and reads, from a configuration space, a plurality of port configuration options from a port configuration data structure. The host system 212 selects, from the plurality of port configuration options, a port configuration option. Based on the requirements of the system 200 which anticipates a connection to a first port (e.g., port 250A) via ETH, a connection to a second port (e.g., port 250B) via PCIe, a connection to a third port (e.g., port 250C) via PCIe, and a connection to a fourth port (e.g., port 250D) via PCIe, host system 212 may select a port configuration option. The host system 212 provides the selection to the memory sub-system 110. As previously described, the selection is provided to the memory sub-system 110 using a port configuration request which includes a port configuration option identifier (e.g., PCOI 8 of FIG. 3).

The port configuration component 113 receives the port configuration request including the port configuration option identifier. The port configuration component 113 obtains, from an entry of the port configuration data structure identified by the port configuration option identifier (e.g., PCOI 8), a list of port configurations. The port configuration component 113 configures, using the list of port configurations, the plurality of ports 250A-D for use by SOCs. The port configuration component 113 locks the configuration of the plurality of ports 250A-D.

Host system 212 may further create and allocate a namespace to an I/O controller of a physical function of the connected port (e.g., 250A). Namespaces are logical divisions of the memory devices (e.g., memory device 130 and/or 140) of the memory sub-system 110. In other words, memory device 130 and/or 140 is formatted into logical blocks and a range of logical block addresses (LBA) associated with a subset of the logical blocks of the memory device 130 and/or 140 is defined as a namespace. Subsequent host system of SOC 210 (e.g., host system 214) is connected to a virtual function of the connected port (e.g., 250A). Host system 214 may further create and allocate one or more namespaces to an I/O controller of the virtual function of the connected port (e.g., 250A).

One or more additional SOCs (e.g., SOC 220-240) may be connected to the plurality of ports 250B-D. For example, SOC 220 may be connected to port 250B via PCIe, SOC 230 may be connected to port 250C via PCIe, and SOC 240 may be connected to port 250D via PCIe. Accordingly, each host system of the connected SOCs (e.g., SOC 220-240) may be connected to an I/O function of the connected port (e.g., a function of port 250B-D, respectively). For example, host system 222 is connected to a physical function of port 250B, host system 224 is connected to a virtual function of port 250B, host system 232 is connected to a physical function of port 250C, host system 242 is connected to a physical function of port 250D. Thus, each host system of he additional SOCs (e.g., host system 222, 224, 232, and 242) can create and allocate one or more namespaces to an I/O controller of the connected I/O function. Accordingly, during operation, responsive to receiving a memory access command from a host system (e.g., host system 212, 214, 222, 224, 232, or 242), executing, using an I/O controller of an I/O connected to the host system, the memory access command.

FIG. 3 illustrates a port configuration data structure 300 in a configuration space of the memory sub-system 110 of FIG. 1, in accordance with some embodiments of the present disclosure. Port configuration data structure 300 includes a plurality of rows. Each row corresponds to a port configuration option and is identified by a port configuration option identifier (PCOI) (e.g., PCOI 0-15). As previously described, a number of port configuration options is dictated by a number of available ports for the memory sub-system 110 of FIG. 1 and a number of supported physical interface (PHY). Each row includes a list of port configurations, each of which includes a port identifier, a physical interface (PHY), and a communication protocol associated with the PHY.

For example, PCOI 8 includes a list of port configurations. A first port configuration of the list of port configuration of PCOI 0 has a port identifier of Port 0, a PHY of ETH, and a communication protocol of NVMe-OF. A second port configuration of the list of port configuration of PCOI 0 has a port identifier of Port 1, a PHY of PCIe, and a communication protocol of NVMe. A third port configuration of the list of port configuration of PCOI 0 has a port identifier of Port 2, a PHY of PCIe, and a communication protocol of NVMe. A fourth port configuration of the list of port configuration of PCOI 0 has a port identifier of Port 3, a PHY of PCIe, and a communication protocol of NVMe.

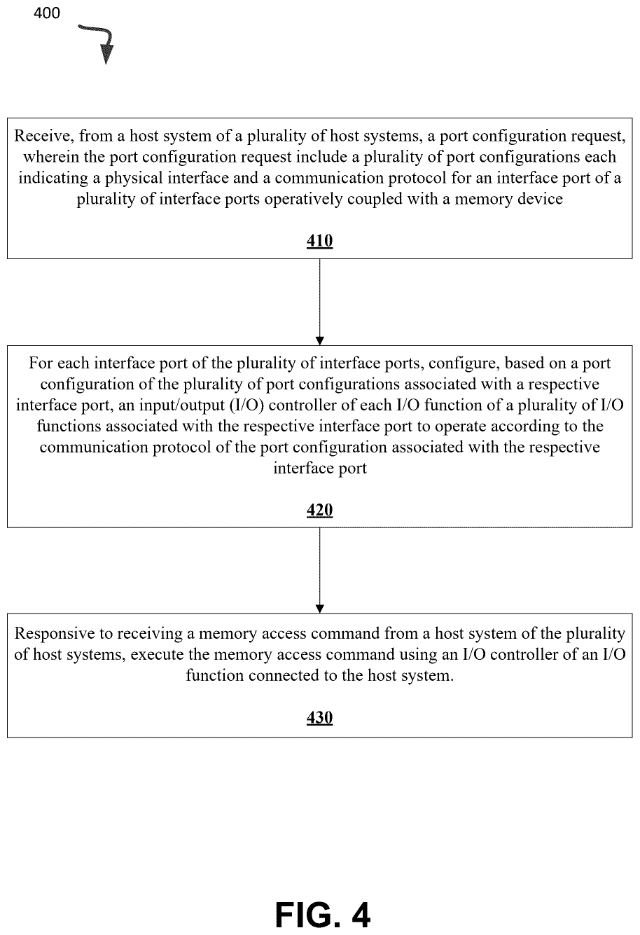

FIG. 4 is a flow diagram of an example method 400 to enable multiple physical layer configuration of memory sub-system with multiple ports, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the port configuration component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic receives, from a host system of a plurality of host systems, a port configuration request. The port configuration request may include a plurality of port configurations. Each port configuration of the plurality of port configurations of indicates a physical interface and a communication protocol for an interface port of the plurality of interface ports.

The plurality of host systems is made up of one or more host systems in a plurality of system on a chips (SOCs) (e.g., a first SOC, a second SOC, a third SOC, and a fourth SOC). Accordingly, a first subset of the plurality of host systems is included in the first SOC connected to a first interface port, a second subset of the plurality of host systems is included in the second SOC connected to a second interface port, a third subset of the plurality of host systems is included in the third SOC connected to a third interface port, and a fourth subset of the plurality of host systems is included in the fourth SOC connected to a fourth interface port.

As previously described, the host system may query a configuration space that stores a port configuration data structure that includes the plurality of port configuration options. Each port configuration option can be identified by a port configuration options identifier and includes a list of port configurations. Each port configuration includes a port identifier, a physical interface (PHY), and a communication protocol associated with the PHY. The communication protocol can be a non-volatile memory express (NVMe) or a non-volatile memory express over fabric (NVMe-oF). The PHY can be ethernet or peripheral component interconnect express (PCIe).

At operation 420, for each interface port of the plurality of interface ports, the processing logic configures an input/output (I/O) controller of each I/O function of a plurality of I/O functions associated with the respective interface port to operate according to the communication protocol of the port configuration associated with the respective interface port. The configuration may be based on a port configuration of the plurality of port configurations associated with a respective interface port. The plurality of I/O functions associated with the respective interface port may include a physical function and one or more virtual functions. Each I/O controller may be allocated a range of logical block addresses (LBA) of the memory device.

As previously described, a port of the plurality of ports may be identified by a port identifier of a respective port configuration. The port may be assigned a PHY and a communication protocol of the respective port configuration by enabling (or configuring) an I/O controller of each of the one or more I/O functions of the port to manage commands based on the communication protocol of the respective port configuration. After configuring the plurality of ports, the configuration may be locked to prevent further change.

At operation 430, responsive to receiving a memory access command from a host system of the plurality of host systems, the processing logic executes the memory access command using an I/O controller of an I/O function connected to the host system.

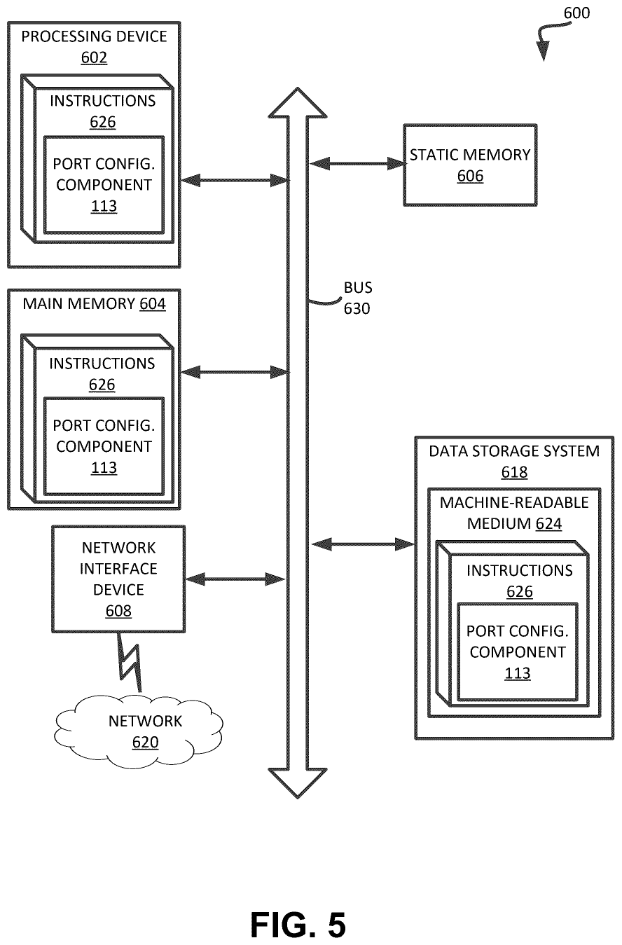

FIG. 5 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the port configuration component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to a port configuration component (e.g., the port configuration component 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device;
a plurality of interface ports operatively coupled with the memory device; and
a processing device, operatively coupled with the memory device, to perform operations comprising:
receiving, from a host system of a plurality of host systems, a port configuration request, wherein the port configuration request comprises a plurality of port configurations each indicating a physical interface and a communication protocol for a respective interface port of the plurality of interface ports;
for each interface port of the plurality of interface ports, configuring, based on a port configuration of the plurality of port configurations associated with the respective interface port, an input/output (I/O) controller of each I/O function of a plurality of I/O functions associated with the respective interface port to operate according to the communication protocol of the port configuration associated with the respective interface port; and
responsive to receiving a memory access command from the host system of the plurality of host systems, executing the memory access command using the I/O controller of the I/O function connected to the host system.

2. The system of claim 1, wherein the communication protocol comprises one of: non-volatile memory express (NVMe) or non-volatile memory express over fabric (NVMe-oF).

3. The system of claim 1, wherein the plurality of port configurations is stored in a configuration space of the memory device.

4. The system of claim 1, wherein the physical interface comprises one of: ethernet or peripheral component interconnect express (PCIe).

5. The system of claim 1, wherein the plurality of I/O functions associated with the respective interface port comprises a physical function and one or more virtual functions.

6. The system of claim 1, wherein each I/O controller is allocated a range of logical block addresses (LBA) of the memory device.

7. The system of claim 1, wherein a first subset of the plurality of host systems comprises one or more host systems of a first system on a chip (SOC) connected to a first interface port of the plurality of interface ports, a second subset of the plurality of host systems comprises one or more host systems of a second SOC connected to a second interface port of the plurality of interface ports, a third subset of the plurality of host systems comprises one or more host systems of a third SOC connected to a third interface port of the plurality of interface ports, and a fourth subset of the plurality of host systems comprises host systems of a fourth SOC connected to a fourth interface port of the plurality of interface ports.

8. A method comprising:
receiving, from a host system of a plurality of host systems, a port configuration request, wherein the port configuration request comprises a plurality of port configurations each indicating a physical interface and a communication protocol for a respective interface port of a plurality of interface ports operatively coupled with a memory device;
for each interface port of the plurality of interface ports, configuring, based on a port configuration of the plurality of port configurations associated with the respective interface port, an input/output (I/O) controller of each I/O function of a plurality of I/O functions associated with the respective interface port to operate according to the communication protocol of the port configuration associated with the respective interface port; and
responsive to receiving a memory access command from the host system of the plurality of host systems, executing the memory access command using the I/O controller of the I/O function connected to the host system.

9. The method of claim 8, wherein the communication protocol comprises one of: non-volatile memory express (NVMe) or non-volatile memory express over fabric (NVMe-oF).

10. The method of claim 8, wherein the plurality of port configurations is stored in a configuration space of the memory device.

11. The method of claim 8, wherein the physical interface comprises one of: ethernet or peripheral component interconnect express (PCIe).

12. The method of claim 8, wherein the plurality of I/O functions associated with the respective interface port comprises a physical function and one or more virtual functions.

13. The method of claim 8, wherein each I/O controller is allocated a range of logical block addresses (LBA) of the memory device.

14. The method of claim 8, wherein a first subset of the plurality of host systems comprises one or more host systems of a first system on a chip (SOC) connected to a first interface port of the plurality of interface ports, a second subset of the plurality of host systems comprises one or more host systems of a second SOC connected to a second interface port of the plurality of interface ports, a third subset of the plurality of host systems comprises one or more host systems of a third SOC connected to a third interface port of the plurality of interface ports, and a fourth subset of the plurality of host systems comprises one or more host systems of a fourth SOC connected to a fourth interface port of the plurality of interface ports.

15. A non-transitory computer-readable storage medium comprising instructions that, when executed by a processing device, cause the processing device to perform operations comprising:
receiving, from a host system of a plurality of host systems, a port configuration request, wherein the port configuration request comprises a plurality of port configurations each indicating a physical interface and a communication protocol for a respective interface port of a plurality of interface ports operatively coupled with a memory device;
for each interface port of the plurality of interface ports, configuring, based on a port configuration of the plurality of port configurations associated with the respective interface port, an input/output (I/O) controller of each I/O function of a plurality of I/O functions associated with the respective interface port to operate according to the communication protocol of the port configuration associated with the respective interface port; and
responsive to receiving a memory access command from the host system of the plurality of host systems, executing the memory access command using the I/O controller of the I/O function connected to the host system.

16. The non-transitory computer-readable storage medium of claim 15, wherein the communication protocol comprises one of: non-volatile memory express (NVMe) or non-volatile memory express over fabric (NVMe-oF).

17. The non-transitory computer-readable storage medium of claim 15, wherein the plurality of port configurations is stored in a configuration space of the memory device.

18. The non-transitory computer-readable storage medium of claim 15, wherein the physical interface comprises one of: ethernet or peripheral component interconnect express (PCIe).

19. The non-transitory computer-readable storage medium of claim 15, wherein the plurality of I/O functions associated with the respective interface port comprises a physical function and one or more virtual functions.

20. The non-transitory computer-readable storage medium of claim 15, wherein each I/O controller is allocated a range of logical block addresses (LBA) of the memory device.
